(19) United States
(12) Patent Application Publication
(10) Pub. No.: US 2024/0426411 A1
(43) Pub. Date: Dec. 26, 2024

(54) BEND RESTRICTOR

(71) Applicant: NEXANS, Courbevoie (FR)

(72) Inventor: Ulf SVAROD, AREMARK (NO)

(21) Appl. No.: 18/543,358

(22) Filed: Dec. 18, 2023

(30) Foreign Application Priority Data
Dec. 16, 2022 (EP) 22306918.8

(51) Int. Cl. F16L 43/00; H02G 3/04

(52) U.S. Cl. CPC F16L 43/00; H02G 3/0462

(57) ABSTRACT

A bend restrictor for restricting the bending of a cable has at least two pipe section (48) and at least one clamp section (46), where the pipe section (48) has an outward facing flange at each end and at least an additional outward facing flange arranged between the end flanges. The clamp section (46) has an inward facing flange at each end, and a pipe shaped middle section therebetween. The distance between the outward facing end flange and the additional outward facing flange of the pipe section (48) is adapted to receive the inward facing flange of the clamp section (46).

### RELATED APPLICATION

This application claims the benefit of priority from European Patent Application No. 22 306 918.8, filed on Dec. 16, 2023, the entirety of which is incorporated by reference.

### FIELD OF THE INVENTION

The present invention relates to a bend restrictor, especially to a bend restrictor for a cable.

### BACKGROUND

During the handling and installation of a cable, both offshore and onshore, it is challenging to ensure that the cable is not damaged. It doesn't take much to over-bend or kink a cable, especially when the cable has a heavy and/or large termination unit at the end of the cable or cable jointing unit anywhere along the cable length.

A cable accessory, commonly called Bend Limiter or Bend Restrictor, is a common product in the offshore cable industry.

A bend restrictor is usually attached to the cable termination unit and to both ends of a cable jointing unit. To protect the cable from over-bending, the bend restrictor encloses the cable in a certain length and it is flexible up to a certain point where it locks into a rigid arc that has a certain radius called a locking radius.

Bend restrictors are usually made of steel, plastic or a composite material, but regardless of the material the existing bend restrictors designs today are more or less based on the same geometric concept.

### PRIOR ART

EP3564569A1 relates to a bend restrictor The bend restrictor comprises at least one pipe section and at least one clamp section wherein the pipe section comprises an outward facing flange at each end, the pipe section is split in the longitudinal direction into at least two parts, wherein the clamp section comprises an inward facing flange at each end and a pipe shaped middle section therebetween, wherein the clamp section is split in the longitudinal direction into at least two parts, wherein said parts are connectable through bolt connections, or through locking pin connections or through straps and wherein each inward facing flange is adapted to receive the outward facing flange of a pipe section.

NO320897 discloses a bend restrictor comprising pipe sections consisting of two halves connectable through bolt connections. The pipe sections comprise an outward directed flange at each end of the pipe section. The pipe sections are interconnected by clamps which consist of two halves connectable through bolt connections. The clamps have an inward facing flange adapted to receive the outward facing flange of two adjacent pipe sections. Both the pipe sections and the clamps are split in halves in the longitudinal direction. Each pipe section and each clamp are equipped with sacrificial anodes as they are prepared of metal that would otherwise not withstand humid conditions including subsea installation.

Prior art solutions are usually made of heavy single elements, which increase the difficulty and time required for the assembly of the bend restrictor. In addition, the prior art bend restrictor has a total weight that is quite high, which means that much of the structural capacity of the prior art bend restrictor must be used to support itself in addition to supporting the cable.

The present invention attempts to solve this challenge, or at least to improve on existing solutions.

### SUMMARY OF THE INVENTION

An objective of the present invention is to provide a bend restrictor with reduced cost and installation time.

According to a first aspect, the invention relates to a bend restrictor for restricting the bending of a cable comprising at least one pipe section and at least one clamp section
wherein each pipe section comprises an outward facing flange at each end, and at least an additional outward facing flange arranged between the end flanges,
wherein the clamp section comprises an inward facing flange at each end, and a pipe shaped middle section therebetween,
wherein the distance between each of the outward facing end flanges and the additional outward facing flange of the pipe section is adapted to receive the inward facing flange of the clamp section.

Here, “the distance between each of the outward facing end flanges and the additional outward facing flange of the pipe section” refers to the distance between each of the outward facing end flanges and its respectively closest additional outward facing flange.

In an embodiment, the outward facing end flange may be a circular flange.

In an embodiment, the additional outward facing flange may be a circular flange.

In an embodiment, the locking radius of the bend restrictor is equal to or over the minimum allowable bending radius of the cable.

The bend restrictor is flexible up to a certain point where it locks into a rigid arc that has a certain radius called a locking radius.

In an embodiment, the distance between the end flange and the additional outward facing flange on the pipe section enables the inward facing flange on the clamp section, when in use, to move in a section between the end flange and the additional outward facing flange of the pipe section so that the bend restrictor does not allow the cable to be bent below the minimum allowable bending radius of the cable.

In an embodiment, the distance between the outward facing end flange and the additional outward facing flange of the pipe section may be larger than the width of the inward facing flange of the clamp section, so that the axes of the pipe section and the adjacent clamp section can have an inclination relative to each other.

In an embodiment, the distance between the outward facing end flange and the adjacent additional outward facing flange of the pipe section may be larger than the width of the inward facing flange of the clamp section, so that a position of the central axis of the pipe section to the central axis of the adjacent clamp section can vary between a first and second positions, wherein in the first position the axes are aligned and in the second position the axes are inclined relative to each other.

In an embodiment, a maximum angle between adjacent clamp and pipe sections is the angle between the central axis of the pipe section and the central axis of the adjacent clamp section and the angle is comprised between 0.5 and 15 degrees; 1 and 12 degrees; or 1.5 and 9 degrees.

In an embodiment, the pipe section may comprise an outward facing flange at each end, and at least two additional outward facing flanges arranged between the end flanges.

In an embodiment, the pipe section may be split in the longitudinal direction into at least two parts.

In an embodiment, the at least two parts of the pipe section may be connectable through bolt connections, or through locking pin connections or through straps.

In an embodiment, the clamp section may be split in the longitudinal direction into at least two parts.

In an embodiment, the at least two parts of the clamp section may be connectable through bolt connections, or through locking pin connections or through straps.

In an embodiment, the clamp section may be made of a rigid material. In other words, the clamp section may not be made of an elastic material.

In an embodiment, the pipe section may be made of a rigid material. In other words, the clamp section may not be made of an elastic material.

In an embodiment, the clamp section may comprise a structural steel, a polymer or a fibre-reinforced polymer material.

In an embodiment, the pipe section may comprise a structural steel, a polymer or a fibre-reinforced polymer material.

In an embodiment, the pipe shaped middle section of the clamp section may feature at least one aperture, thereby reducing the weight of the clamp section.

In an embodiment, the pipe shaped middle section of the clamp section may comprise a plurality of elongated elements extending between the two inward facing flanges. In an embodiment, the elongated elements may not be in contact with each other. In other words, there may be space between the elongated elements. This allows to further reduce the weight of the clamps, while continuing to protect the cable.

In an embodiment, said pipe section has a pipe length LP and said clamp section has clamp length LC, the dimensional ratio LC/LP is set from 0.9 to 4.1.

In an embodiment, said pipe section defines a distance DBPF between said outward facing end flange and said additional outward facing flange, said clamp section defining a thickness TCF of said inward facing flange of the clamp section, the dimensional ratio DBPF/TCF is set from 1.4 to 3.8.

In an embodiment, said clamp section has an inner diameter IDC and the pipe section has an outer diameter ODP, the dimensional ratio IDC/ODP is set from 1.02 to 1.3.

In an embodiment, said pipe section has an outer diameter ODP and pipe length LP, the dimensional ratio ODP/LP is set from 0.9 to 2.2.

The pipe length LP and the distance DBPF are taken along a pipe longitudinal axis along which the pipe section longitudinally extends. The outer diameter ODP is taken perpendicularly to said pipe longitudinal axis.

The clamp length LC and the thickness TCF are taken along a clamp longitudinal axis along which the clamp section longitudinally extends. The inner diameter IDC is taken perpendicularly to said clamp longitudinal axis.

### BRIEF DESCRIPTION OF THE DRAWINGS

The present invention will now be described in further details with reference to the enclosed drawings. A person skilled in the art will appreciate that different features illustrated in different embodiments may be combined to provide further embodiments of the present invention.

FIG. 1a is a schematic cross-sectional view of a first prior art bend restrictor.

FIG. 1b illustrates the clamp and the pipe sections of the first prior art bend restrictor.

FIG. 2a is a schematic cross-sectional view of a second prior art bend restrictor.

FIG. 2b illustrates the clamp and the pipe sections of the second prior art bend restrictor.

FIG. 3a is a schematic cross-sectional view of a third prior art bend restrictor.

FIG. 3b illustrates the clamp and the pipe sections of the third prior art bend restrictor.

FIG. 4a is a schematic cross-sectional view of a bend restrictor according to the first embodiment.

FIG. 4b illustrates the clamp and the pipe sections of the first embodiment of the bend restrictor.

FIG. 5a is a schematic cross-sectional view of a bend restrictor according to the second embodiment.

FIG. 5b illustrates the clamp and the pipe sections of the second embodiment of the bend restrictor.

FIG. 6a is a cross-sectional view of a bend restrictor according to the first embodiment.

FIG. 6b is a side view of a bend restrictor according to the first embodiment.

FIG. 6c is a detail view of FIG. 6a.

FIG. 6d is another detail view of FIG. 6a.

FIG. 7a is a cross-sectional view of a bend restrictor according to the second embodiment.

FIG. 7b is a side view of a bend restrictor according to the second embodiment.

FIG. 8 is a cross-sectional view of a bend restrictor according to the first embodiment.

FIG. 9 is a cross-sectional view of a bend restrictor according to the first embodiment.

### DETAILED DESCRIPTION OF THE INVENTION

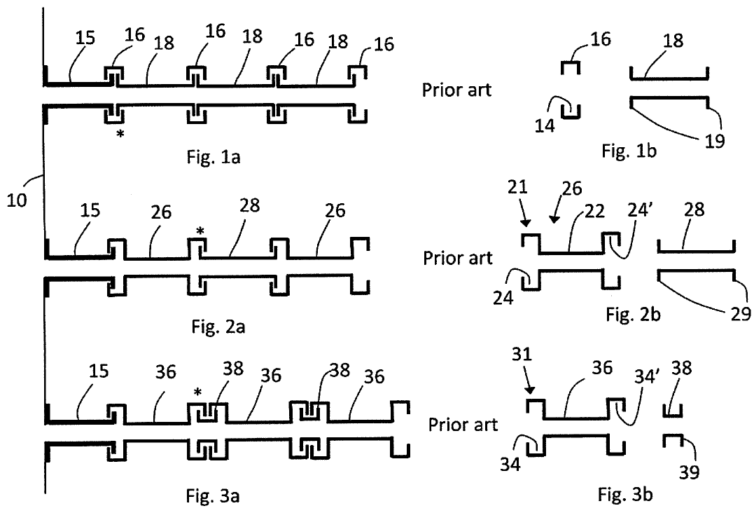

A prior art bend restrictor is illustrated on FIGS. 1 to 3.

In the first example of prior art, as illustrated in FIGS. 1a and 1b, the end section 15 is connected to an equipment wall 10. A pipe section 18 is connected to the end section 15 with a clamp section 16. The end section 15 comprises an outward extending flange at the end extending from the equipment wall 10. The pipe section 18 also comprises outward extending flanges 19 at each end thereof. The clamp section 16 comprises one inward facing flange 14 adapted to receive the outward facing extending flanges of two pipe sections or the end section 15 and the first pipe section. The cable to be protected by the bend restrictor is not shown in the schematic representation, but the longitudinal open passage therethrough is easily visible. In the schematic illustration it is also not visible that each pipe section and each clamp section are longitudinally split in at least two sections. In this prior art solution, the clamp sections have a very limited contribution to the length of the bend restrictor.

The prior art bend restrictor on FIG. 1a comprises three pipe sections and four clamp sections. If these are split in half the bend restrictor comprises fourteen pieces. These pieces are, if designed as in NO320897, connected with twenty-eight bolts.

A weak point of the prior art bend restrictor is at the position of the first clamped, marked with an asterisk (*). Three elements are connected at this point. The inward facing flange of the clamp section is designed such that a limited movement of the outward flange of the first pipe section in relation to the outward flange of the end section is possible such that a limited bending of the bend restrictor and the cable arranged therein is made possible. The outward flange of the pipe section at * is often the weakest point of the bend restrictor.

FIGS. 2a and 2b illustrate a second prior art bend restrictor using the same schematic method of illustration. The pipe section 28 is similar to the first prior art pipe section, the pipe sections may be split in the longitudinal direction, assembled with or without bolt connections or similar elements. When no bolts are used, the two or more pieces of the pipe section 28 are kept in place by the clamp sections.

The clamp section 26 has another design. The clamp section 26 comprise a longitudinal pipe shaped middle section 22 with a diameter similar to the diameter of the main part of the pipe section 28. The pipe section 28 also comprises outward extending flanges 29 at each end thereof. At each end the clamp section 26 comprises a radial extension 21 with an inward facing flange 24, 24′ adapted to receive the outward facing extending flanges of the pipe sections 28 or the end section 15 and the first pipe section. Compared to the first prior art bend restrictor, the bend restrictor of FIG. 2a comprises no point where two pipe sections are directly connected within the same inward facing flange, in that the inward facing flanges are separated by the pipe shaped middle section 22. The bending forces are distributed between the two ends of the first clamp section 26 connected to the end section 15. The position * of the first pipe section flange is moved further away from the equipment wall 10, which increases bending moment capacity.

The design of the clamp section further provides for the clamp section to contribute considerably to the length of the bend restrictor. The bend restrictor illustrated on FIG. 2a has a similar length as the prior art bend restrictor of FIG. 1a but comprises less parts. The bend restrictor on FIG. 2a comprises one pipe section and two clamp sections, which makes six pieces if they are split in two.

FIGS. 3a and 3b illustrate a third prior art bend restrictor using the same schematic illustration. In this embodiment the clamp section 36 is similar to the clamp section of FIG. 2a. However, the pipe sections 38 are reduced in length. The pipe section 38 comprises outward extending flanges 39 at each end thereof. At each end the clamp section 36 comprises a radial extension 31 with an inward facing flange 34, 34′ adapted to receive the outward facing extending flanges of the pipe sections 38 or the end section 15 and the first pipe section. The solution can be prepared without bolt connections between the parts of the longitudinally split pipe sections. Also, an increase in the bending moment capacity due to movement of the weak point further away from the wall 10 is achieved. With the third prior art solution a further increase in bending moment capacity is obtained due to the fact that with this design the radial extensions 31 of two adjacent clamp sections 36 can interact directly and transfer compression forces directly between the clamp sections without interacting with the pipe section 38 connected by the two clamp sections.

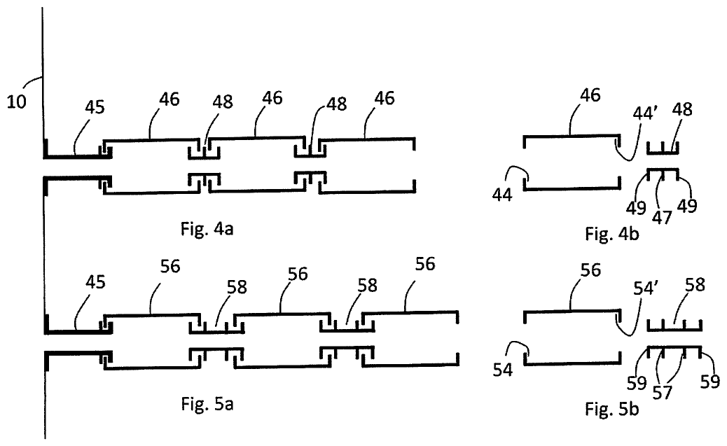

FIGS. 4a and 4b illustrate a first embodiment of the present invention using the same schematic method of illustration. The end section 45 is connected to an equipment wall 10. A pipe section 48 is connected to the end section 45 with a clamp section 46. The end section 45 comprises two outward extending flanges at the end extending from the equipment wall 10. The pipe section 48 also comprises outward extending end flanges 49 at each end thereof and at least an additional outward extending flange 47.

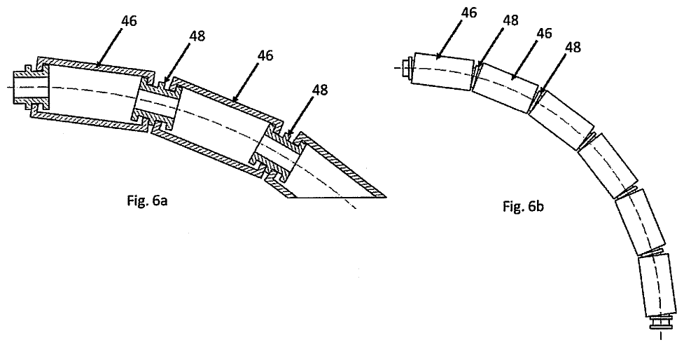

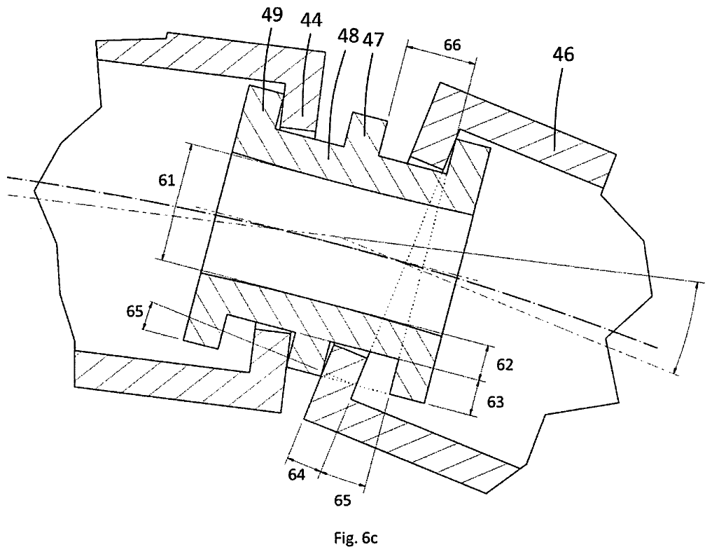

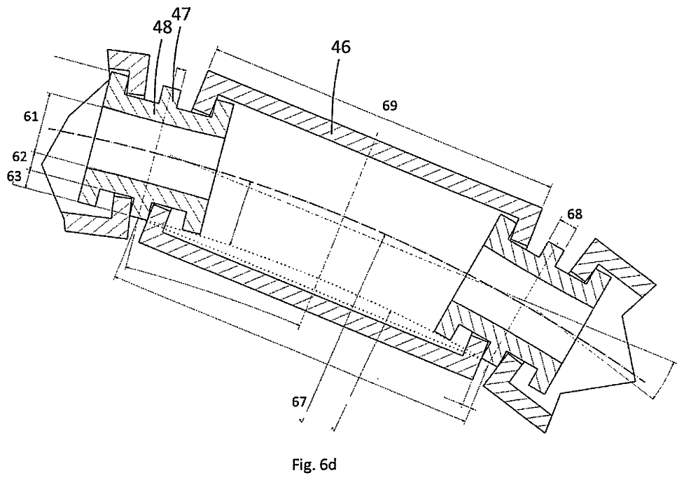

The distance between each of the end flange 49 and the additional flange 47 on the pipe section 48 shall enable the inward facing flange 44 on the clamp section 46 to move freely within a calculated limitation. This calculated limitation of movement controls the angle between each clamp section 46 and an adjacent clamp section 46 when the bend restrictor is locked into a rigid arc (see FIGS. 6a and 6b) and the calculated limitation is determined by the geometric relation between the diameter of the cable, the wall thickness of the pipe section 48, the height of the flange 49 on the pipe section 48, the thickness of the flange 44 of the clamp section 46, the angle between two adjacent clamp sections 46.

The distance between the outward extending end flange 49 and the additional flange 47 on the pipe 48 may be determined by the following equation and is illustrated on FIG. 6c:
CD: 61: Cable diameter including clearance towards the inside of the pipe section 48
PWT: 62: Wall thickness of the pipe section 48
PFH: 63: Height of the outward extending pipe end flange 49 of the pipe section 48
CFT: 64: Thickness of the inward facing flange 44 of the clamp section 46
ABC: 65: Angle between the central axis of the pipe section 48 and the central axis of the adjacent clamp section 46
DBPF: 66: Distance Between two Pipe Flanges (between an end flange 49 and an adjacent additional flange 47)

$$DBPF = ( ( CD + ( 2 \times PWT ) + ( 2 \times PFH ) ) \times tan ( ABC ) ) + ( CFT / cos ( ABC ) )$$

In addition, the locking radius characterizes the maximum bending of the cable allowed by the bend restrictor. In other words, when bent, a cable protected by the bend restrictor cannot have a bending radius under the locking radius, which describes the radius of the rigid arc below which the bend restrictor cannot move.

The locking radius may be determined by the following equation and is illustrated on FIGS. 6c and 6d:
LR: 67: Locking Radius, where bend restrictor is locked into a rigid arc
TPF: 68: Thickness of additional outward facing pipe flange 47
LC: 69: Length of Clamp section 46

$$LR = [ ( LC + ( 2 \times ( ( TPF / 2 ) \times cos ( ABC ) ) ) ) / ( 2 \times sin ( ABC ) ) ] + ( CD / s + PWT + PFH )$$

At each end the clamp section 46 comprises an inward facing flange 44, 44′. The cable to be protected by the bend restrictor is not shown in the schematic representation, but the longitudinal open passage therethrough is easily visible. In the schematic illustration it is also not visible that each clamp section may be longitudinally split in at least two sections and each pipe section may be longitudinally split in at least two sections. In this embodiment, the pipe sections have a very limited contribution to the length of the bend restrictor.

If the bend restrictor is prepared in steel for installation in moist climate including submerged in water the parts have to be protected from corrosion to obtain a reasonable life span. For this purpose, sacrificial anodes may be installed on each part or element.

FIGS. 5a and 5b illustrate a second embodiment of the present invention using the same schematic method of illustration. The end section 45 is connected to an equipment wall 10. A pipe section 58 is connected to the end section 45 with a clamp section 56. The end section 45 comprises two outward extending flanges at the end extending from the equipment wall 10. The pipe section 58 also comprises outward extending end flanges 59 at each end thereof and two additional outward extending flanges 57, at a certain distance from each of the adjacent end flanges 59, respectively. The distance between the end flange 59 and the adjacent additional flange 57 on the pipe section 58 shall enable the inward facing flange 54 on the clamp section 56 to move freely within a calculated limitation, as explained for the first embodiment.

Each end of the clamp section 56 comprises an inward facing flange 54, 54′. The cable to be protected by the bend restrictor is not shown in the schematic representation, but the longitudinal open passage therethrough is easily visible. In the schematic illustration it is also not visible that each clamp section may be longitudinally split in at least two sections and each pipe section may be longitudinally split in at least two sections. In this embodiment, the pipe sections have a very limited contribution to the length of the bend restrictor.

FIGS. 6a, 6b and 6c show a cross-sectional and a side views of a first alternative of a bend restrictor according to the first embodiment in further detail. In this illustration the bend restrictor is made of steel. A number of pipe sections 48 are connected with clamp sections 46 arranged therebetween. In this first alternative, the clamp sections 46 are a continuous cylinder. The assembly is much faster than in the prior art, especially due to the small size and weight of the pipe sections 48.

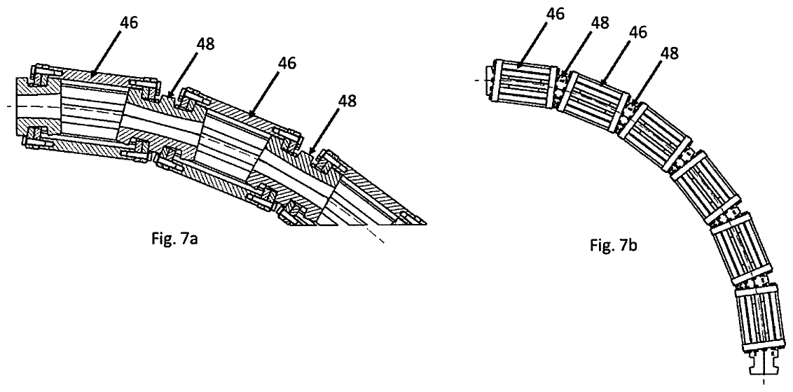

FIGS. 7a and 7b show a cross-sectional and a side views of a bend restrictor according to the second embodiment in further detail. In this illustration the bend restrictor is made of steel. A number of pipe sections 48 are connected with clamp sections 46 arranged therebetween. In this alternative, the clamp sections 46 are made of a plurality of elongated elements, here cylinders (tubes or bars) between two discs at each end. In other words the clamp sections 46 feature at least one aperture (here a plurality of apertures) which results in a substantial reduction in weight of the clamp. This alternative further improves the assembly speed for the bend restrictor, combining the effect of the small size and weight of the pipe sections 48 and a lighter clamp section than in the first alternative shown in FIGS. 6a and 6b which can lead to an even faster assembly.

Following are dimensional examples of a bend restrictor for a cable having a cable diameter DC of 25 mm, 250 mm and 500 mm. These examples provide a example of how to correlate these dimensional ratios with other parameters but are not restrictive examples.

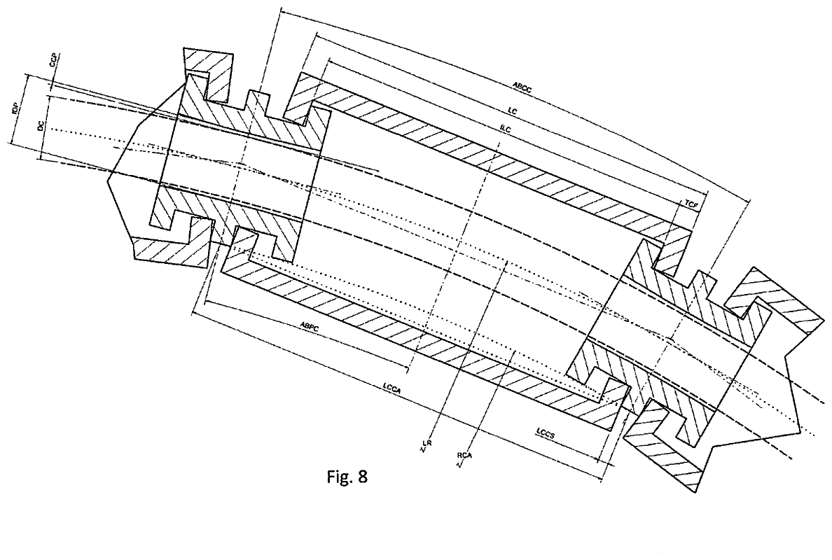

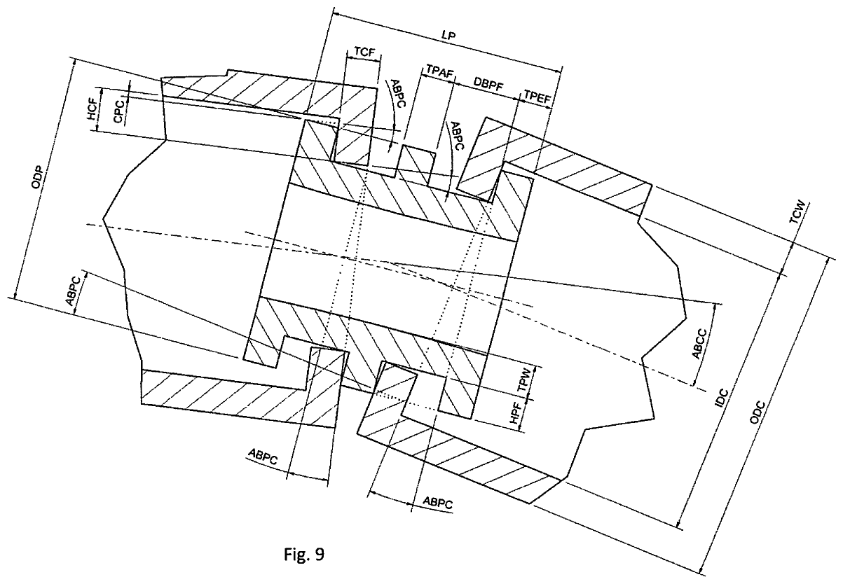

The list and meaning of the following abbreviations are provided above. Abbreviations are shown on FIGS. 8 and 9.

### LC/LP Ratio

Dimensional ratio between LC (Length of Clamp) and LP (Length of Pipe) is mainly controlled by the DC parameter (Diameter of Cable), the LR parameter (Locking Radius of the bend restrictor), the ABCC parameter (Angle Between a Clamp and the adjacent Clamp when BR is locked into a rigid arc) and the TCF parameter (Thickness of Clamp Flange).
The DC parameter (Diameter of Cable) is set by designer, where diameter can vary from 25 to 500 mm. For the scenarios listed below DC is set to 25, 250 and 500 mm.
The LR parameter (Locking Radius of the bend restrictor) is set by designer. Typically LR is based on minimum bending radius data for the cable, but for the scenarios listed below LR is set to a calculated value based on a LR/DC ratio of 10:

$$LR = DC \times 10.$$

The ABCC parameter is set by designer, typically an angle from 10 to 20 degrees. For the scenarios listed below ABCC is set to 10, 15 and 20 degrees.
The TCF parameter is set by designer, typically from 5 to 70 mm. For the scenarios listed below TCF is set to 5, 10, 40 and 70 mm.

$$LC / LP = \frac{\begin{matrix}( 2 \times ( LR - ( ( ( DC + ( 2 \times CCP ) ) + ( 2 \times TPW ) + ( 2 \times HPF ) ) / 2 ) ) \times \\ sin ABPC ) - ( 2 \times ( ( TPAF / 2 ) \times cos ABPC )\end{matrix}}{\begin{matrix}TPAF + ( 2 \times TPEF ) + ( 2 * ( ( ( ( DC + ( 2 \times CCP ) ) + ( 2 \times TPW ) + \\ ( 2 \times HPF ) ) \times tan ABPC ) + ( TCF / cos ABPC ) )\end{matrix}}$$

When DC=25 mm, LR=500 mm, ABCC=10 degrees and TCF=5 mm, the LC/LP ratio becomes: 1.74
When DC=250 mm, LR=2500 mm, ABCC=10 degrees and TCF=5 mm, the LC/LP ratio becomes: 5.92 *
When DC=500 mm, LR=5000 mm, ABCC=10 degrees and TCF=5 mm, the LC/LP ratio becomes: 7.29 *
When DC=25 mm, LR=500 mm, ABCC=10 degrees and TCF=10 mm, the LC/LP ratio becomes: 1.49
When DC=250 mm, LR=2500 mm, ABCC=10 degrees and TCF=10 mm, the LC/LP ratio becomes: 4.32 *
When DC=500 mm, LR=5000 mm, ABCC=10 degrees and TCF=10 mm, the LC/LP ratio becomes: 5.95 *
When DC=25 mm, LR=500 mm, ABCC=10 degrees and TCF=40 mm, the LC/LP ratio becomes: n/a **
When DC=250 mm, LR=2500 mm, ABCC=10 degrees and TCF=40 mm, the LC/LP ratio becomes: 1.58
When DC=500 mm, LR=5000 mm, ABCC=10 degrees and TCF=40 mm, the LC/LP ratio becomes: 2.79
When DC=25 mm, LR=500 mm, ABCC=10 degrees and TCF=70 mm, the LC/LP ratio becomes: n/a **
When DC=250 mm, LR=2500 mm, ABCC=10 degrees and TCF=70 mm, the LC/LP ratio becomes: 0.93 ***
When DC=500 mm, LR=5000 mm, ABCC=10 degrees and TCF=70 mm, the LC/LP ratio becomes: 1.78
When DC=25 mm, LR=500 mm, ABCC=15 degrees and TCF=5 mm, the LC/LP ratio becomes: 2.12
When DC=250 mm, LR=2500 mm, ABCC=15 degrees and TCF=5 mm, the LC/LP ratio becomes: 6.62 *
When DC=500 mm, LR=5000 mm, ABCC=15 degrees and TCF=5 mm, the LC/LP ratio becomes: 7.78 *
When DC=25 mm, LR=500 mm, ABCC=15 degrees and TCF=10 mm, the LC/LP ratio becomes: 1.73
When DC=250 mm, LR=2500 mm, ABCC=15 degrees and TCF=10 mm, the LC/LP ratio becomes: 5.14 *
When DC=500 mm, LR=5000 mm, ABCC=15 degrees and TCF=10 mm, the LC/LP ratio becomes: 6.67 *
When DC=25 mm, LR=500 mm, ABCC=15 degrees and TCF=40 mm, the LC/LP ratio becomes: n/a **
When DC=250 mm, LR=2500 mm, ABCC=15 degrees and TCF=40 mm, the LC/LP ratio becomes: 2.13
When DC=500 mm, LR=5000 mm, ABCC=15 degrees and TCF=40 mm, the LC/LP ratio becomes: 3.54
When DC=25 mm, LR=500 mm, ABCC=15 degrees and TCF=70 mm, the LC/LP ratio becomes: n/a **
When DC=250 mm, LR=2500 mm, ABCC=15 degrees and TCF=70 mm, the LC/LP ratio becomes: 1.30
When DC=500 mm, LR=5000 mm, ABCC=15 degrees and TCF=70 mm, the LC/LP ratio becomes: 2.38
When DC=25 mm, LR=500 mm, ABCC=20 degrees and TCF=5 mm, the LC/LP ratio becomes: 2.50
When DC=250 mm, LR=2500 mm, ABCC=20 degrees and TCF=5 mm, the LC/LP ratio becomes: 7.02 *
When DC=500 mm, LR=5000 mm, ABCC=20 degrees and TCF=5 mm, the LC/LP ratio becomes: 8.02 *
When DC=25 mm, LR=500 mm, ABCC=20 degrees and TCF=10 mm, the LC/LP ratio becomes: 1.99
When DC=250 mm, LR=2500 mm, ABCC=20 degrees and TCF=10 mm, the LC/LP ratio becomes: 5.66 *
When DC=500 mm, LR=5000 mm, ABCC=20 degrees and TCF=10 mm, the LC/LP ratio becomes: 7.06 *
When DC=25 mm, LR=500 mm, ABCC=20 degrees and TCF=40 mm, the LC/LP ratio becomes: n/a **
When DC=250 mm, LR=2500 mm, ABCC=20 degrees and TCF=40 mm, the LC/LP ratio becomes: 2.56
When DC=500 mm, LR=5000 mm, ABCC=20 degrees and TCF=40 mm, the LC/LP ratio becomes: 4.07 ****
When DC=25 mm, LR=500 mm, ABCC=20 degrees and TCF=70 mm, the LC/LP ratio becomes: n/a **
When DC=250 mm, LR=2500 mm, ABCC=20 degrees and TCF=70 mm, the LC/LP ratio becomes: 1.61
When DC=500 mm, LR=5000 mm, ABCC=20 degrees and TCF=70 mm, the LC/LP ratio becomes: 2.83

Based on the various scenario above, the dimensional ratio between LC and LP can be from 0.9 to 4.1
*=Not a realistic scenario. Clamp flanges is too thin and weak for the typical weight of a cable with this diameter.
**=Not a realistic scenario. Clamps are clashing with their adjacent clamp due to the combination of parameters.
***=The lowest ratio of the realistic scenarios. Value is rounded down to 0.9
****=The highest ratio of the realistic scenarios. Value is rounded up to 4.1

### DBPF/TCF Ratio

Dimensional ratio between DBPF (Distance Between Pipe additional Flange and adjacent pipe end flange) and TCF (Thickness of Clamp Flange) is mainly controlled by the DC parameter (Diameter of Cable), the ABCC parameter (Angle Between a Clamp and the adjacent Clamp when BR is locked into a rigid arc) and the TCF parameter (Thickness of Clamp Flange).
The DC parameter (Diameter of Cable) is set by designer, where diameter can vary from 25 to 500 mm. For the scenarios listed below DC is set to 25, 250 and 500 mm.
The ABCC parameter is set by designer, typically an angle from 10 to 20 degrees. For the scenarios listed below ABCC is set to 10, 15 and 20 degrees.
The TCF parameter is set by designer, typically from 5 to 70 mm. For the scenarios listed below TCF is set to 5, 10, 40 and 70 mm.

$$DBPF / TCF = \frac{\begin{matrix}( ( ( DC + ( 2 \times CCP ) ) + ( 2 \times TPW ) + ( 2 \times HPF ) ) \times tan ABPC ) + \\ ( TCF / cos ABPC )\end{matrix}}{TCF}$$

When DC=25 mm, ABCC=10 degrees and TCF=5 mm, the DBPF/TCF ratio becomes: 1.74
When DC=250 mm, ABCC=10 degrees and TCF=5 mm, the DBPF/TCF ratio becomes: 5.68 *
When DC=500 mm, ABCC=10 degrees and TCF=5 mm, the DBPF/TCF ratio becomes: 10.05 *
When DC=25 mm, ABCC=10 degrees and TCF=10 mm, the DBPF/TCF ratio becomes: 1.49 ***
When DC=250 mm, ABCC=10 degrees and TCF=10 mm, the DBPF/TCF ratio becomes: 3.45 *
When DC=500 mm, ABCC=10 degrees and TCF=10 mm, the DBPF/TCF ratio becomes: 5.64 *
When DC=25 mm, ABCC=10 degrees and TCF=40 mm, the DBPF/TCF ratio becomes: n/a **
When DC=250 mm, ABCC=10 degrees and TCF=40 mm, the DBPF/TCF ratio becomes: 1.79
When DC=500 mm, ABCC=10 degrees and TCF=40 mm, the DBPF/TCF ratio becomes: 2.33
When DC=25 mm, ABCC=10 degrees and TCF=70 mm, the DBPF/TCF ratio becomes: n/a **
When DC=250 mm, ABCC=10 degrees and TCF=70 mm, the DBPF/TCF ratio becomes: 1.55
When DC=500 mm, ABCC=10 degrees and TCF=70 mm, the DBPF/TCF ratio becomes: 1.86
When DC=25 mm, ABCC=15 degrees and TCF=5 mm, the DBPF/TCF ratio becomes: 2.12
When DC=250 mm, ABCC=15 degrees and TCF=5 mm, the DBPF/TCF ratio becomes: 8.04 *
When DC=500 mm, ABCC=15 degrees and TCF=5 mm, the DBPF/TCF ratio becomes: 14.62 *
When DC=25 mm, ABCC=15 degrees and TCF=10 mm, the DBPF/TCF ratio becomes: 1.73
When DC=250 mm, ABCC=15 degrees and TCF=10 mm, the DBPF/TCF ratio becomes: 4.70 *
When DC=500 mm, ABCC=15 degrees and TCF=10 mm, the DBPF/TCF ratio becomes: 7.99 *
When DC=25 mm, ABCC=15 degrees and TCF=40 mm, the DBPF/TCF ratio becomes: n/a **
When DC=250 mm, ABCC=15 degrees and TCF=40 mm, the DBPF/TCF ratio becomes: 2.19
When DC=500 mm, ABCC=15 degrees and TCF=40 mm, the DBPF/TCF ratio becomes: 3.01
When DC=25 mm, ABCC=15 degrees and TCF=70 mm, the DBPF/TCF ratio becomes: n/a **
When DC=250 mm, ABCC=15 degrees and TCF=70 mm, the DBPF/TCF ratio becomes: 1.83
When DC=500 mm, ABCC=15 degrees and TCF=70 mm, the DBPF/TCF ratio becomes: 2.30
When DC=25 mm, ABCC=20 degrees and TCF=5 mm, the DBPF/TCF ratio becomes: 2.50
When DC=250 mm, ABCC=20 degrees and TCF=5 mm, the DBPF/TCF ratio becomes: 10.43 *
When DC=500 mm, ABCC=20 degrees and TCF=5 mm, the DBPF/TCF ratio becomes: 19.25 *
When DC=25 mm, ABCC=20 degrees and TCF=10 mm, the DBPF/TCF ratio becomes: 1.99
When DC=250 mm, ABCC=20 degrees and TCF=10 mm, the DBPF/TCF ratio becomes: 5.95 *
When DC=500 mm, ABCC=20 degrees and TCF=10 mm, the DBPF/TCF ratio becomes: 10.36 *
When DC=25 mm, ABCC=20 degrees and TCF=40 mm, the DBPF/TCF ratio becomes: n/a **
When DC=250 mm, ABCC=20 degrees and TCF=40 mm, the DBPF/TCF ratio becomes: 2.59
When DC=500 mm, ABCC=20 degrees and TCF=40 mm, the DBPF/TCF ratio becomes: 3.72 ****
When DC=25 mm, ABCC=20 degrees and TCF=70 mm, the DBPF/TCF ratio becomes: n/a **
When DC=250 mm, ABCC=20 degrees and TCF=70 mm, the DBPF/TCF ratio becomes: 2.11
When DC=500 mm, ABCC=20 degrees and TCF=70 mm, the DBPF/TCF ratio becomes: 2.74

Based on the various scenario above, the dimensional ratio between DBPF and TCF can be from 1.4 to 3.8
*=Not a realistic scenario. Clamp flanges is too thin and weak for the typical weight of a cable with this diameter.
**=Not a realistic scenario. Clamps are clashing with their adjacent clamp due to the combination of parameters.
***=The lowest ratio of the realistic scenarios. Value is rounded down to 1.4
****=The highest ratio of the realistic scenarios. Value is rounded up to 3.8

### IDC/ODP Ratio

Dimensional ratio between IDC (Inner Diameter of Clamp) and ODP (Outer Diameter of Pipe) is mainly controlled by the DC parameter (Diameter of Cable), the ABCC parameter (Angle Between a Clamp and the adjacent Clamp when BR is locked into a rigid arc), the TCF parameter (Thickness of Clamp Flange) and the CPC parameter (Clearance between Pipe and Clamp when BR is locked into a rigid arc).
The DC parameter (Diameter of Cable) is set by designer, where diameter can vary from 25 to 500 mm. For the scenarios listed below DC is set to 25, 250 and 500 mm.
The ABCC parameter is set by designer, typically an angle from 10 to 20 degrees. For the scenarios listed below ABCC is set to 10, 15 and 20 degrees.
The TCF parameter is set by designer, typically from 5 to 70 mm. For the scenarios listed below TCF is set to 5, 10, 40 and 70 mm.
The CPC parameter is set by the designer, typically from 1 to 5 mm. For the scenarios listed below CPC is set to 2 mm.

$$IDC / OP = \frac{\begin{matrix}( ( ( DC + ( 2 \times CCP ) ) + ( 2 * TPW ) ) / cos ABPC ) + ( TCF * \\ tan ABPC ) + ( 2 * ( ( HPF / cos ABCC ) + ( TPF * sin ABPC ) + CPC ) )\end{matrix}}{( DC + ( 2 \times CCP ) ) + ( 2 \times TPW ) + ( 2 \times HPF )}$$

When DC=25 mm, ABCC=10 degrees and TCF=5 mm, the IDC/ODP ratio becomes: 1.13
When DC=250 mm, ABCC=10 degrees and TCF=5 mm, the IDC/ODP ratio becomes: 1.02 *
When DC=500 mm, ABCC=10 degrees and TCF=5 mm, the IDC/ODP ratio becomes: 1.01 *
When DC=25 mm, ABCC=10 degrees and TCF=10 mm, the IDC/ODP ratio becomes: 1.12
When DC=250 mm, ABCC=10 degrees and TCF=10 mm, the IDC/ODP ratio becomes: 1.03 *
When DC=500 mm, ABCC=10 degrees and TCF=10 mm, the IDC/ODP ratio becomes: 1.02 *
When DC=25 mm, ABCC=10 degrees and TCF=40 mm, the IDC/ODP ratio becomes: n/a **
When DC=250 mm, ABCC=10 degrees and TCF=40 mm, the IDC/ODP ratio becomes: 1.04
When DC=500 mm, ABCC=10 degrees and TCF=40 mm, the IDC/ODP ratio becomes: 1.03 ***
When DC=25 mm, ABCC=10 degrees and TCF=70 mm, the IDC/ODP ratio becomes: n/a **
When DC=250 mm, ABCC=10 degrees and TCF=70 mm, the IDC/ODP ratio becomes: 1.05
When DC=500 mm, ABCC=10 degrees and TCF=70 mm, the IDC/ODP ratio becomes: 1.04
When DC=25 mm, ABCC=15 degrees and TCF=5 mm, the IDC/ODP ratio becomes: 1.15
When DC=250 mm, ABCC=15 degrees and TCF=5 mm, the IDC/ODP ratio becomes: 1.03 *
When DC=500 mm, ABCC=15 degrees and TCF=5 mm, the IDC/ODP ratio becomes: 1.02 *
When DC=25 mm, ABCC=15 degrees and TCF=10 mm, the IDC/ODP ratio becomes: 1.15
When DC=250 mm, ABCC=15 degrees and TCF=10 mm, the IDC/ODP ratio becomes: 1.04 *
When DC=500 mm, ABCC=15 degrees and TCF=10 mm, the IDC/ODP ratio becomes: 1.02 *
When DC=25 mm, ABCC=15 degrees and TCF=40 mm, the IDC/ODP ratio becomes: n/a **
When DC=250 mm, ABCC=15 degrees and TCF=40 mm, the IDC/ODP ratio becomes: 1.06
When DC=500 mm, ABCC=15 degrees and TCF=40 mm, the IDC/ODP ratio becomes: 1.04
When DC=25 mm, ABCC=15 degrees and TCF=70 mm, the IDC/ODP ratio becomes: n/a **
When DC=250 mm, ABCC=15 degrees and TCF=70 mm, the IDC/ODP ratio becomes: 1.08
When DC=500 mm, ABCC=15 degrees and TCF=70 mm, the IDC/ODP ratio becomes: 1.05
When DC=25 mm, ABCC=20 degrees and TCF=5 mm, the IDC/ODP ratio becomes: 1.17 ****
When DC=250 mm, ABCC=20 degrees and TCF=5 mm, the IDC/ODP ratio becomes: 1.04 *
When DC=500 mm, ABCC=20 degrees and TCF=5 mm, the IDC/ODP ratio becomes: 1.03 *
When DC=25 mm, ABCC=20 degrees and TCF=10 mm, the IDC/ODP ratio becomes: 1.18
When DC=250 mm, ABCC=20 degrees and TCF=10 mm, the IDC/ODP ratio becomes: 1.05 *
When DC=500 mm, ABCC=20 degrees and TCF=10 mm, the IDC/ODP ratio becomes: 1.03 *
When DC=25 mm, ABCC=20 degrees and TCF=40 mm, the IDC/ODP ratio becomes: n/a **
When DC=250 mm, ABCC=20 degrees and TCF=40 mm, the IDC/ODP ratio becomes: 1.08
When DC=500 mm, ABCC=20 degrees and TCF=40 mm, the IDC/ODP ratio becomes: 1.06
When DC=25 mm, ABCC=20 degrees and TCF=70 mm, the IDC/ODP ratio becomes: n/a **
When DC=250 mm, ABCC=20 degrees and TCF=70 mm, the IDC/ODP ratio becomes: 1.11
When DC=500 mm, ABCC=20 degrees and TCF=70 mm, the IDC/ODP ratio becomes: 1.07

Based on the various scenario above, the dimensional ratio between IDC and ODP can be from 1.02 to 1.3
*=Not a realistic scenario. Clamp flanges is too thin and weak for the typical weight of a cable with this diameter.
**=Not a realistic scenario. Clamps are clashing with their adjacent clamp due to the combination of parameters.
***=The lowest ratio of the realistic scenarios. Value is rounded down to 1.02 (if the CPC parameter is set to 1 mm instead of 2 mm, the IDC/ODP ratio becomes: 1.024)
****=The highest ratio of the realistic scenarios. Value is rounded up to 1.3 (if the CPC parameter is set to 5 mm instead of 2 mm, the IDC/ODP ratio becomes: 1.31)

### ODP/LP Ratio

Dimensional ratio between ODP (Outer Diameter of Pipe) and LP (length of Pipe) is mainly controlled by the DC parameter (Diameter of Cable), the ABCC parameter (Angle Between a Clamp and the adjacent Clamp when BR is locked into a rigid arc) and the TCF parameter (Thickness of Clamp Flange).
The DC parameter (Diameter of Cable) is set by designer, where diameter can vary from 25 to 500 mm. For the scenarios listed below DC is set to 25, 250 and 500 mm.
The ABCC parameter is set by designer, typically an angle from 10 to 20 degrees. For the scenarios listed below ABCC is set to 10, 15 and 20 degrees.
The TCF parameter is set by designer, typically from 5 to 70 mm. For the scenarios listed below TCF is set to 5, 10, 40 and 70 mm.

$$ODP / LP = \frac{( DC + ( 2 \times CCP ) ) + ( 2 \times TPW ) + ( 2 \times HPF )}{\begin{matrix}TPAF + ( 2 \times TPEF ) + ( 2 * ( ( ( ( DC + ( 2 \times CCP ) ) + ( 2 \times \\ TPW ) + ( 2 \times HPF ) ) \times tan ABPC ) + ( TCF / cos ABPC ) )\end{matrix}}$$

When DC=25 mm, ABCC=10 degrees and TCF=5 mm, the ODP/LP ratio becomes: 1.41
When DC=250 mm, ABCC=10 degrees and TCF=5 mm, the ODP/LP ratio becomes: 3.86 *
When DC=500 mm, ABCC=10 degrees and TCF=5 mm, the ODP/LP ratio becomes: 4.58 *
When DC=25 mm, ABCC=10 degrees and TCF=10 mm, the ODP/LP ratio becomes: 1.01
When DC=250 mm, ABCC=10 degrees and TCF=10 mm, the ODP/LP ratio becomes: 2.98 *
When DC=500 mm, ABCC=10 degrees and TCF=10 mm, the ODP/LP ratio becomes: 3.85 *
When DC=25 mm, ABCC=10 degrees and TCF=40 mm, the ODP/LP ratio becomes: n/a **
When DC=250 mm, ABCC=10 degrees and TCF=40 mm, the ODP/LP ratio becomes: 1.47
When DC=500 mm, ABCC=10 degrees and TCF=40 mm, the ODP/LP ratio becomes: 2.12 ****
When DC=25 mm, ABCC=10 degrees and TCF=70 mm, the ODP/LP ratio becomes: n/a **
When DC=250 mm, ABCC=10 degrees and TCF=70 mm, the ODP/LP ratio becomes: 1.11
When DC=500 mm, ABCC=10 degrees and TCF=70 mm, the ODP/LP ratio becomes: 1.58
When DC=25 mm, ABCC=15 degrees and TCF=5 mm, the ODP/LP ratio becomes: 1.25
When DC=250 mm, ABCC=15 degrees and TCF=5 mm, the ODP/LP ratio becomes: 2.87 *
When DC=500 mm, ABCC=15 degrees and TCF=5 mm, the ODP/LP ratio becomes: 3.26 *
When DC=25 mm, ABCC=15 degrees and TCF=10 mm, the ODP/LP ratio becomes: 0.92 ***
When DC=250 mm, ABCC=15 degrees and TCF=10 mm, the ODP/LP ratio becomes: 2.36 *
When DC=500 mm, ABCC=15 degrees and TCF=10 mm, the ODP/LP ratio becomes: 2.87 *
When DC=25 mm, ABCC=15 degrees and TCF=40 mm, the ODP/LP ratio becomes: n/a **
When DC=250 mm, ABCC=15 degrees and TCF=40 mm, the ODP/LP ratio becomes: 1.30
When DC=500 mm, ABCC=15 degrees and TCF=40 mm, the ODP/LP ratio becomes: 1.78
When DC=25 mm, ABCC=15 degrees and TCF=70 mm, the ODP/LP ratio becomes: n/a **
When DC=250 mm, ABCC=15 degrees and TCF=70 mm, the ODP/LP ratio becomes: 1.01
When DC=500 mm, ABCC=15 degrees and TCF=70 mm, the ODP/LP ratio becomes: 1.38
When DC=25 mm, ABCC=20 degrees and TCF=5 mm, the ODP/LP ratio becomes: 1.12
When DC=250 mm, ABCC=20 degrees and TCF=5 mm, the ODP/LP ratio becomes: 2.29 *
When DC=500 mm, ABCC=20 degrees and TCF=5 mm, the ODP/LP ratio becomes: 2.52 *
When DC=25 mm, ABCC=20 degrees and TCF=10 mm, the ODP/LP ratio becomes: 0.85
When DC=250 mm, ABCC=20 degrees and TCF=10 mm, the ODP/LP ratio becomes: 1.94 *
When DC=500 mm, ABCC=20 degrees and TCF=10 mm, the ODP/LP ratio becomes: 2.28 *
When DC=25 mm, ABCC=20 degrees and TCF=40 mm, the ODP/LP ratio becomes: n/a **
When DC=250 mm, ABCC=20 degrees and TCF=40 mm, the ODP/LP ratio becomes: 1.16
When DC=500 mm, ABCC=20 degrees and TCF=40 mm, the ODP/LP ratio becomes: 1.54
When DC=25 mm, ABCC=20 degrees and TCF=70 mm, the ODP/LP ratio becomes: n/a **
When DC=250 mm, ABCC=20 degrees and TCF=70 mm, the ODP/LP ratio becomes: 0.93
When DC=500 mm, ABCC=20 degrees and TCF=70 mm, the ODP/LP ratio becomes: 1.23

Based on the various scenario above, the dimensional ratio between ODP and LP can be from 0.9 to 2.2
*=Not a realistic scenario. Clamp flanges is too thin and weak for the typical weight of a cable with this diameter.
**=Not a realistic scenario. Clamps are clashing with their adjacent clamp due to the combination of parameters.
***=The lowest ratio of the realistic scenarios. Value is rounded down to 0.9
****=The highest ratio of the realistic scenarios. Value is rounded up to 2.2

### Abbreviations

BR: Bend Restrictor
DC: Diameter of Cable—also réf. 61 in the drawings.
   DC is set by designer, typically the maximum allowable outer diameter of cable.
   Cable diameter can vary from 25 to 500 mm.
CCP: Clearance between Cable and inside of Pipe.
   CCP is set by designer, typically from 1 to 3 mm of radially clearance, depending on the shape and texture roughness of the cable surface.
CPC: Clearance between Pipe and Clamp when BR is locked into a rigid arc.
   CPC is set by the designer, typically from 1 to 5 mm, depending on the diametrical sizing of the BR components.
TPW: Thickness of Pipe tubular Wall—also réf. 62 in the drawings.
   TPW is set by designer, typically 5 to 40 mm. The higher the thickness is set, the higher the bending moment capacity of the BR becomes.
HPF: Height of Pipe Flanges—also réf. 63 in the drawings.
   HPF is set by designer, typically 10 to 50 mm. The higher the height is set, the higher the bending moment capacity of the BR becomes due to the ODC (Outer Diameter of the Clamp) increases as a result.
TCF: Thickness of Clamp Flange—also réf. 64 in the drawings.
   TCF is set by designer, typically 5 to 70 mm. The higher the thickness is set, the higher the bending moment capacity of the BR becomes.
TCW: Thickness of Clamp tubular Wall.
   TCW is set by designer, typically 5 to 40 mm. The higher the thickness is set, the higher the bending moment capacity of the BR becomes.
   Pipe wall between the pipe end flanges may consist of other type of steel profile(s) than a typical tubular steel profile. Pipe wall may be attached to the pipe end flanges by welding, bolting or other attachment technique.
TPEF: Thickness of Pipe End Flange.
   TPEF is set by designer, typically 5 to 70 mm. The higher the thickness is set, the higher the bending moment capacity of the BR becomes.
ABCC: Angle Between a Clamp and the adjacent Clamp when BR is locked into a rigid arc.
   Consequently, ABCC is also the angle between pipe and the adjacent pipe when BR is locked into a rigid arc.
   ABCC is set by designer, typically from 10 to 20 degrees. The higher the angle is set, the longer the Clamps becomes.
ABPC: Angle Between a Pipe and the adjacent Clamp when BR is locked into a rigid arc—also réf. 65 in the drawings.
   DBPF is set as a result of other parameter.

$$ABPC = ABCC / 2$$

HCF: Height of Clamp Flange
   HCF is set as a result of other parameters.

$$HCF = ( HPF / cos ABPC ) + ( TPF * sin ABCP ) + CPC$$

ODP: Outer Diameter of Pipe.
   ODP is a result of other parameters.

$$ODP = IDP + ( 2 \times TPW ) + ( 2 \times HPF ) \\ ODP = ( DC + ( 2 \times CCP ) ) + ( 2 \times TPW ) + ( 2 \times HPF )$$

IDP: Inner Diameter of Pipe.
   IDP is a result of other parameters.

$$IDP = DC + ( 2 \times CCP )$$

DBPF: Distance Between Pipe additional Flange and adjacent pipe end flange—also réf. 66 in the drawings.
   DBPF is set as a result of other parameters.

$$DBPF = ( ODP \times tan ABPC ) + ( TCF / cos ABPC ) ( \\ DBPF = ( ( IDP + ( 2 \times TPF ) + ( 2 \times HPF ) ) \times tan ABPC ) + ( TCF / cos ABPC ) \\ DBPF = ( ( ( DC + ( 2 \times CCP ) ) + ( 2 \times TPW ) + ( 2 \times HPF ) ) \times tan ABPC ) + ( TCF / cos ABPC )$$

LR: Locking Radius of the bend restrictor—also réf. 67 in the drawings
   LR is a radius parameter for a design construction circle.
   The circle, with a radius of LR, is:
      tangential to the central axis of all pipes when BR is locked into a rigid arc.
      concentric with the design construction arc with a radius of RCA.
   LR is set by designer and typically equal or slightly above the allowable minimum bending radius for the cable.
TPAF: Thickness of Pipe Additional Flange (the flange in the middle of pipe)—also réf. 68 in the drawings.
   TPAF is set by designer, typically 5 to 70 mm. The higher the thickness is set, the higher the bending moment capacity of the BR becomes.
IDP: Inner Diameter of Pipe.
   IDP is a result of other parameters.

$$IDP = DC + ( 2 \times CCP )$$

LP: Length of Pipe.
   LP is set as a result of other parameters.

$$LP = TPAF + ( 2 \times TPE ) + ( 2 \times DBPF ) \\ LP = TPAF + ( 2 \times TPEF ) + ( 2 * ( ( ODP \times tan ABPC ) + ( TCF / cos ABPC ) ) \\ LP = TPAF + ( 2 \times TPEF ) + ( 2 * ( ( ( IDP + ( 2 \times TPW ) + ( 2 \times HPF ) ) \times tan ABPC ) + ( TCF / cos ABPC ) ) \\ LP = TPAF + ( 2 \times TPEF ) + ( 2 * ( ( ( ( DC + ( 2 \times CCP ) ) + ( 2 \times TPW ) + ( 2 \times HPF ) ) \times tan ABPC ) + ( TCF / cos ABPC ) )$$

RCA: Radius parameter for a design Construction Arc
   The arc, with a radius of RCA, is:
      tangential to the rim surface of the additional flange of all pipes when BR is locked into a rigid arc.
      concentric with the design construction circle with a radius of LR.
      starting at the midpoint on the rim surface of the additional flange on a pipe and ends at the midpoint on the rim surface of the additional flange on the adjacent pipe.
   RCA is set as a result of other parameters.

$$RCA = LR - ( ODP / 2 )$$

LCCA: Length of Circle Cord for a design construction Arc.
   The arc, with a radius of RCA, is:
      tangential to the rim surface of the additional flange on all pipes when BR is locked into a rigid arc.
      concentric with the design construction circle with a radius of LR.
      starting at the midpoint on the rim surface of the additional flange on a pipe and ends at the midpoint on the rim surface of the additional flange on the adjacent pipe.
   LCCA is set as a result of other parameters.

$$LCCA = 2 \times RCA \times sin ABPC$$

LCCS: Length of Circle Cord for Subtraction.
   LCCS is set as a result of other parameters.

$$LCCS = ( TPAF / 2 ) \times cos ABPC$$

LC: Length of Clamp—also réf. 69 in the drawings.
   LC is set as a result of other parameters.

$$LC = LCCA - ( 2 \times LCCS ) \\ LC = ( 2 \times RCA \times sin ABPC ) - ( 2 \times ( ( TPAF / 2 ) \times cos ABPC ) ) \\ LC = ( 2 \times ( LR - ( ODP / 2 ) ) \times sin ABPC ) - ( 2 \times ( ( TPAF / 2 ) \times cos ABPC ) ) \\ LC = ( 2 \times ( LR - ( ( ( DC + ( 2 \times CCP ) ) + ( 2 \times TPW ) + ( 2 \times HPF ) ) / 2 ) ) \times sin ABPC ) - ( 2 \times ( ( TPAF / 2 ) \times cos ABPC ) ) \\ LC = ( 2 \times ( LR - ( ( ( DC + ( 2 \times CCP ) ) + ( 2 \times TPW ) + ( 2 \times HPF ) ) / 2 ) ) \times sin ABPC ) - ( 2 \times ( ( TPAF / 2 ) \times cos ABPC ) )$$

ILC: Inside Length of Clamp.
   ILC is set as a result of other parameters.

$$ILC = LC - ( 2 \times TCF )$$

IDC: Inner Diameter of Clamp.
   IDC is set as a result of other parameters.

$$IDC = ) ) IDP + ( 2 * TPW ) ) / cos ABPC ) + ( TCF * tan ABPC ) + ( 2 * HCF ) \\ IDC = ( ( ( DC + ( 2 \times CCP ) ) + ( 2 * TPW ) ) / cos ABPC ) + ( TCF * tan ABPC ) + ( 2 * HCF ) \\ IDC = ( ( ( DC + ( 2 \times CCP ) ) + ( 2 * TPW ) ) / cos ABPC ) + ( TCF * tan ABPC ) + ( 2 * ( ( HPF / cos ABPC ) + ( TPF * sin ABPC ) + CPC ) )$$

ODC: Outer Diameter of Clamp.
   ODC is set as a result of other parameters.

$$ODC = IDC + ( 2 * TCW )$$

1. A bend restrictor for restricting the bending of a cable comprising: at least one pipe section and at least one clamp section,
wherein each pipe section comprises an outward facing end flange at each end, and at least an additional outward facing flange arranged between the end flanges,
wherein the clamp section comprises an inward facing flange at each end, and a pipe shaped middle section therebetween, and
wherein the distance between each of the outward facing end flanges and the additional outward facing flange of the pipe section is adapted to receive the inward facing flange of the clamp section.

2. The bend restrictor according to claim 1, wherein the locking radius of the bend restrictor is equal to or over the minimum allowable bending radius of the cable.

3. The bend restrictor according to claim 1, wherein the distance between the outward facing end flange and the adjacent additional outward facing flange of the pipe section is larger than the width of the inward facing flange of the clamp section, so that the axis of the pipe section and the axis of the adjacent clamp section can have an inclination relative to each other.

4. The bend restrictor according to claim 1, wherein the distance between the outward facing end flange and the adjacent additional outward facing flange of the pipe section is larger than the width of the inward facing flange of the clamp section, so that a position of the central axis of the pipe section to the central axis of adjacent clamp section can vary between a first and second positions, wherein in the first position the axes are aligned and in the second position the axes are inclined relative to each other.

5. The bend restrictor according to claim 1, wherein a maximum angle between adjacent clamp and pipe sections is comprised between 1.5 and 9 degrees wherein the angle is measured between the central axis of the pipe section and the central axis of the adjacent clamp section.

6. The bend restrictor according to claim 1, wherein the pipe section comprises an outward facing flange at each end, and at least two additional outward facing flanges arranged between the end flanges.

7. The bend restrictor according to claim 1, wherein the pipe section is split in the longitudinal direction into at least two parts.

8. The bend restrictor according to claim 7, wherein the at least two parts of the pipe section are connectable through bolt connections, or through locking pin connections or through straps.

9. The bend restrictor according to claim 1, wherein the clamp section is split in the longitudinal direction into at least two parts.

10. The bend restrictor according to claim 9, wherein the at least two parts of the clamp section are connectable through bolt connections, or through locking pin connections or through straps.

11. The bend restrictor according to claim 1, wherein the clamp section is made of a rigid material.

12. The bend restrictor according to claim 1, wherein the clamp section comprises a structural steel, a polymer or a fibre-reinforced polymer material.

13. The bend restrictor according to claim 1, wherein the pipe shaped middle section of the clamp section features at least one aperture.

14. The bend restrictor according to claim 1, wherein the pipe shaped middle section of the clamp section comprises a plurality of elongated elements extending between the two inward facing flanges.

15. The bend restrictor according to claim 1, wherein said pipe section has a pipe length LP and said clamp section has clamp length LC, the dimensional ratio LC/LP is set from 0.9 to 4.1.

16. The bend restrictor according to claim 1, wherein said pipe section defines a distance DBPF between said outward facing end flange and said additional outward facing flange, said clamp section defining a thickness TCF of said inward facing flange of the clamp section, the dimensional ratio DBPF/TCF is set from 1.4 to 3.8.

17. The bend restrictor according to claim 1, wherein said clamp section has an inner diameter IDC and the pipe section has an outer diameter ODP, the dimensional ratio IDC/ODP is set from 1.02 to 1.3.

18. The bend restrictor according to claim 1, wherein said pipe section has an outer diameter ODP and pipe length LP, the dimensional ratio ODP/LP is set from 0.9 to 2.2.
